(19) United States
(12) Patent Application Publication
(10) Pub. No.: US 2017/0351916 A1
(43) Pub. Date: Dec. 7, 2017

(54) DEVICE AND METHOD FOR VERIFYING A CONTENT OF AN ANALOG DOCUMENT

(71) Applicant: SIEMENS AKTIENGESELLSCHAFT, MÜNCHEN (DE)

(72) Inventors: Jorge Cuellar, Baierbrunn (DE); Tiago Gasiba, München (DE)

(21) Appl. No.: 15/536,156

(22) PCT Filed: Dec. 2, 2015
(86) PCT No.: PCT/EP2015/078283

§ 371 Date: Jun. 15, 2017

(30) Foreign Application Priority Data
Dec. 19, 2014 (DE) 10 2014 226 660.2

(51) Int. Cl. G06K 9/00; G06K 9/78; G06K 9/03

(52) U.S. Cl. CPC G06K 9/00483; G06K 9/03; G06K 9/78

(57) ABSTRACT

A device for verifying a content of an analog document is provided. The device includes a scanning unit being configured to generate a scan information by scanning the analog document and to store the scan information in a storing element being provided on the analog document, and a verification unit being configured to verify the content of the analog document using the stored scan information. Further, a corresponding method for verifying a content of an analog document is provided. Using the provided device for verifying the content of an analog document, it can be ensured that the content of the analog document is not changed by an attacker. If the content is changed, the verification would fail.

### CROSS-REFERENCE TO RELATED APPLICATIONS

This application claims priority to PCT Application No. PCT/EP2015/078283, having a filing date of Dec. 2, 2015, which is based upon and claims priority to DE Application No. 10 2014 226 660.2, having a filing date of Dec. 19, 2014 the entire contents both of which are hereby incorporated by reference.

### FIELD OF TECHNOLOGY

The following relates to a device for verifying a content of an analog document. The following relates further to a method for verifying a content of an analog document.

### BACKGROUND

In the past, there has been a demand to secure analog documents, specially official and government issued documents. Generally, the used approaches fall into two categories: (i) make it as hard as possible to physically reproduce copy or change the analog document by means of special markers in the document or (ii) ignore the analog content and provide the same information in a digital secure element which is embedded into the document (e.g. E-Pass).

There exist different possibilities of digitally sign physical documents:

a. Usage of standard handwritten signature: this approach is very weak and does not guarantee the integrity of the analog content. Further, anyone with the capability of manually reproducing the signature is able to produce a modified version of the document.
b. Usage of signature and plastification (e.g. plastic cards): this approach is weak and can be attacked using reverse engineering and reassembling procedures. Anyone being capable of manually reproducing the signature and plastifying a document can produce a modified version of the document.
c. Usage of a Digital Secure Element (DSE) in the form of a chip being embedded into the document: this approach is also very weak. According to the current technology, the DSE only protects the digital information, not the analog part of the document. Further, this approach relies on manual inspection, recognition and cross-checking of information.
d. Usage of printed serial numbers which can be recognized through an Optical Character Recognition (OCR) and are checked by hand with a database: this approach is also very weak. It relies on manual inspection, recognition and cross-checking of information. Further, OCR usage is very limited to only a few characters. An analog shape of characters is irrelevant. Known serial numbers could be reused and an attacker could easily fake information which might not be detected by manual inspection.
e. Usage of special materials for the physical analog document: this approach is weak. The document material needs to be specially produced (e.g. bank note) and is not easily reproducible. However, the analog content can still be manipulated using advanced techniques and is not per se secured. Anyone with the capability of producing the special materials can produce a modified version of the document.
f. Usage of special light sensitive markers for the physical document: this approach is weak. This can be for example watermarks, etc. like used in a bank note. However, the analog content can still be manipulated using advanced techniques and is not per se secured. Anyone with the capability of reproducing the markers can produce a modified version of the document.
g. Usage of special stamps, for example “white stamp”, or wax stamp: this approach is very weak. The white stamp or wax stamp, etc., does not guarantee in any way the integrity of the analog part of the document is unchanged. Anyone (e.g. a thief) with a “white stamp” can produce a modified version of the document.

As can be seen, none of the above methods can be reliably used to truly and securely protect or verify the analog content of a document.

### SUMMARY

An aspect relates to an improved way of verifying a content of an analog document.

According to a first aspect, a device for verifying a content of an analog document is provided. The device comprises a scanning unit being configured to generate a scan information by scanning the analog document and to store the scan information in a storing element being provided on the analog document, and a verification unit being configured to verify the content of the analog document using the stored scan information.

The respective unit, e.g. the scanning unit, may be implemented in hardware and/or in software. If said unit is implemented in hardware, it may be embodied as a device, e.g. as a computer or as a processor or as a part of a system, e.g. a computer system. If said unit is implemented in software it may be embodied as a computer program product, as a function, as a routine, as a program code or as an executable object.

The scanning unit and the verification unit may be integrated in one module or they may be located at different places, also remote from each other.

The device is based on the idea to provide digital information of the analog content in the form of scan information directly in a storage element on or in the analog document and to verify the content of the analog document later using the stored scan information.

An analog document in this context may be a standard document in paper form, which is normally printed or handwritten on paper, i.e. it is not in digital format. Examples of analog documents range from ID cards, driving licenses, house or land ownership titles, certificates, etc., but can also be any other kind of document in analog form.

By providing a verification of the content using the scan information, which is generated based on the original analog document, i.e. before anyone had a chance to manipulate or change the document, it may be made sure that, once the document has been scanned and the scan information is stored, it cannot be tampered with, in particular, the analog (e.g. handwritten part) cannot be changed in any way without fail of the verification.

Scanning in this context may refer to a visual capturing of the content of the analog document and converting the captured content into digital data. The scanning unit may use different scanning parameters. Such scanning parameters may be the resolution of the scanning process (e.g. dots per inch (DPI) or pixel per inch (PPI) or the color depth (e.g. black/white (2 bit) or color (8 bit, 16 bit, etc.).

According to an embodiment, the scanning unit is configured to generate a digital signature based on the scan information and to store the digital signature in the storing element.

The signature can be generated using known encoding techniques. For example, the digital signature may be based on a hash function of the digital data of the scanned document.

In one embodiment, the signature may state when verified that the content of the analog document has not been changed.

In another embodiment, the signature may in addition verify the owner of the analog document. In this case, the signature may contain, in addition to information regarding the content of the analog document, a digital signature authenticating the user or owner of the analog document. In this case, the scanning unit may be adapted to communicate with a signing authority, for example using a private/public key technique, for generating the digital signature. The verification unit may again communicate with the signing authority for verifying the digital signature using the public key. The verification unit may for example be used by the signing authority for verifying the validity of the analog document that was signed by said authority.

According to a further embodiment, the scanning unit is configured to generate an error correction information when scanning the analog document and wherein the analog document includes a specific area to which the error correction information is attachable.

In the scanning process of the area or segment of the analog document containing the (analog) content, in the following also called Area 1, some errors due to scanner optics, paper aging or color calibration of the scanning unit may affect the resulting bitmap. Therefore, an error correction code may be implemented. In addition, also color matching and balancing functions may be added, which means that the scanning unit used for scanning the analog document to generate the signature and the scanning process during the verification are matched to each other.

The error correction information resulting from the error correction code being applied to the scanned content may be provided on a specific area of the analog document.

The error correction code may be for example a Reed-Solomon code or any other suitable code. The decoding process may be done in a similar way to turbo-codes.

The idea of the error correction code is to add some redundancy, i.e., some extra bits, to the digital (i.e. scanned) version of the analog document, which the verification unit can use to check the consistency of the analog document and to recover parts of the analog document determined to be corrupted. It should be noted that the error correction code may be used to eliminate failures or errors, and thus inconsistencies, being caused by aging or scanning failures and not being caused by manipulation.

According to a further embodiment, the device further comprises a printing unit being configured to print the error correction information to the specific area.

The error correction information may be printed directly to the analog document or may be printed to a sticker which can be attached to the analog document.

According to a further embodiment, the scanning unit is configured to generate a horizontal error correction information and a vertical error correction information.

According to this embodiment, for every scanned line and column there are some corresponding parity bits on the horizontal and vertical axis respectively. Instead of one parity bit for every line, a set of parity bits may be added for a set of scanned lines.

According to a further embodiment, the printing unit is configured to print the horizontal error correction information to a first segment of the specific area and to print the vertical error correction information to a second segment of the specific area.

The first segment may be a horizontal area and the second segment may be a vertical area on the analog document. These segments are outside of the Area 1 containing the content of the analog document.

These areas can be optional. In case these areas are not used, the scanning process may be very sensitive to any errors and/or paper aging (which can be avoided by e.g. involving the document in transparent plastic). If these areas are used, they may be generated by a computer and post-printed on the analog document, directly or indirectly as explained above.

According to a further embodiment, the analog document includes a calibration pattern and wherein the scanning unit is configured to be calibrated using the calibration pattern before scanning the analog document.

To avoid errors due to different calibration parameters of the scanning unit, a calibration pattern is provided on the analog document. The calibration pattern may be used by the scanning unit to work properly, e.g. to be calibrated to scan the relevant parts of the analog document.

According to a further embodiment, the storing element is a visual representation of a binary code being attachable to the analog document.

The visual representation may be printed to the analog document directly or may be printed to a piece of paper, like a sticker, and may be attached to the document. The binary code may be a bar code or a QR code or any other kind of suitable code being printable.

According to a further embodiment, the storing element is a digital secure element being included in the analog document.

According to this embodiment, digital secure elements (DSE) like they are used for ID cards or the like is included in the analog document. Commonly used DSEs may contain the same (and eventually more) information as present in the analog document. This information however is disconnected from the analog part such that the information cannot be used to automatically protect, to a high degree of precision, the analog contents of the document. The commonly used DSEs therefore protect only the digital information contained within themselves.

According to this embodiment, the DSE may be used in a broader way as it may be used to verify the analog content of the analog document. Thus, the scan information may be stored in this secure element. For example, the signature being generated using the scan information may be stored in the secure element.

Thus, according to this embodiment, instead of printing the scan information, the scan information may be digitally stored.

According to a further embodiment, the scanning unit is configured to store as scan information at least one scanned version of the analog document.

One or more scanned versions of the analog document may be safely stored into the secure element. Thus, the content of the analog document may be scanned and subsequently stored in digital form in the secure element.

According to a further embodiment, the verification unit is configured to scan the analog document and to generate a comparison result by comparing the scanned analog document with the at least one stored scanned version of the analog document. In one embodiment, the verification unit may be integrated into the storing element in the form of a digital secure element (DSE). In another embodiment, the verification unit may be arranged outside the DSE.

The verification unit may scan, using the scanning unit or another scanning unit, the analog document. At this point, the analog document might already be manipulated or changed. After scanning, the verification unit may retrieve the stored scan information from the storing element and may compare the stored scan information with the actual scanning version of the analog document.

According to a further embodiment, the verification unit is configured to verify the content of the analog document based on the comparison result.

The verification unit may decide whether the content has been changed or not using a threshold. If a correlation between the two scanned versions is higher than the threshold, the content of the analog document can be verified. If the correlation is lower than the threshold, the content cannot be verified and the verification fails.

According to a further embodiment, the scanning unit is configured to scan the analog document using different scanning parameters and to store for each scanning parameter one scanned version of the analog document.

According to this embodiment, different scanned versions can be stored. The different scanned versions can be generated using different scanning parameters, e.g. scanning resolution, number of scanned colors, etc.

According to a further embodiment, the verification unit is configured to scan the analog document and to generate a plurality of comparison results by comparing the scanned analog document with each of the stored scanned versions of the analog document and to verify the content of the analog document using the plurality of comparison results.

The scanning unit and the verification unit may for example perform the following:

First, the analog document is scanned into scanning image S.

Then, one or more different scanned versions Vₙ of the analog document are used for verification. These versions Vₙ are stored by the scanning unit in the storing element.

For each Vₙ, the following is computed:

Xₙ=1−|S−Vₙ|²,

wherein 0<Xₙ<1 and whereby Xₙ−>0 denotes a low correlation and Xₙ−>1 denotes a high correlation. A high correlation denotes a passed verification and a low correlation denotes a failed verification.

Subsequently, P=F(X₁, X₂, . . . Xₙ) is computed where the function F is a monotone function on each component (that is: if Xᵢ is less or equal than X*ᵢ then F{X₁, X₂, . . . , Xᵢ . . . Xₙ) is less or equal than F{X₁, X₂, . . . , X*ᵢ . . . Xₙ)). It can be interpreted as a composed measure of the distance of S to the space of single Xᵢ's.

Some examples of such function are the following:

If any Xₙ is such that Xₙ<threshold, then P=O, otherwise P=1
P=PRODUCT(Xₙ). Notice here that if any Xₙ is equal to 0, then P=0, otherwise P is in 0 . . . 1.

At the end it is determined:

if P<t1: verification failed
if P>t2: verification passed
else: indeterminate
whereby t1 and t2 are two adjustable parameters. For the verification of colored images, a color calibration procedure may be used. The scanning image can then be split into, e.g. three different components, R, G and B (Red, Green, Blue) or any other color model. The different components may then be compared against VRₙ, VGₙ and VBₙ using the same procedure described above.

The verification using different scanned version may be combined with error correction codes as described above. In this case, the areas of the analog document containing ECC codes may be scanned as S_{E,n} in addition to the document S, whereby n represents the ECC area n. ECC decoding may be performed using an ECC decoding algorithm (e.g. Turbo Decoding).

This may result in S_{D}=Decode(S, S_{E,1}, S_{E,2}, . . . , E_{E,n}). Then the verification is performed as described above, wherein S corresponds to S_{D}.

Using the herein described device, analog content may be securely protected against tampering. The analog content and verification procedure is protected against natural aging and scanning uncertainties. Due to the described ECC mechanisms, the procedure is very robust against scanning noise and, e.g. document aging. If used together with plastification, the procedure is extremely robust, since document aging is not so critical. Further, using a DSE for the verification based on different scanned versions of the analog document, protection against document cloning may be provided.

The described device may provide a variable approach for verifying the content of an analog document due to the following reasons: The amount of ECC may be varied and thus the error protection level may be varied; the scanning resolution may be varied and thus the precision; the threshold levels for verification procedure, etc. may be varied; the verification may be used with both black-and-white as also with color documents. Thus, the described device may be used with a variety of different documents, in a variety of precision and protection levels.

Any embodiment of the first aspect may be combined with any embodiment of the first aspect to obtain another embodiment of the first aspect.

According to a second aspect, a method for verifying a content of an analog document is provided. The method comprises the following steps: generating a scan information by scanning the analog document, storing the scan information in a storing element being provided on the analog document, and verifying the content of the analog document using the stored scan information.

According to a further aspect, the invention relates to a computer program product comprising a program code for executing the above-described method for verifying a content of an analog document when run on at least one computer.

A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

The embodiments and features described with reference to the apparatus of the present invention apply mutatis mutandis to the method of embodiments of the present invention.

Further possible implementations or alternative solutions of the invention also encompass combinations that are not explicitly mentioned herein of features described above or below with regard to the embodiments. The person skilled in the art may also add individual or isolated aspects and features to the most basic form of embodiments of the invention.

### BRIEF DESCRIPTION

Some of the embodiments will be described in detail, with reference to the following figures, wherein like designations denote like members, wherein:

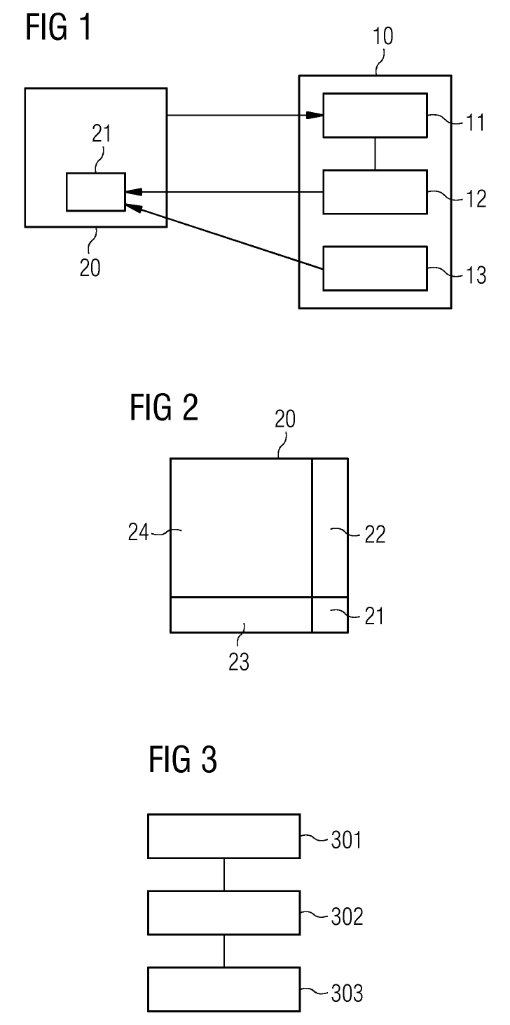

FIG. 1 shows a schematic block diagram of a device for verifying a content of an analog document, in accordance with embodiments of the present invention;

FIG. 2 shows an embodiment of an analog document used by the device of FIG. 1, in accordance with embodiments of the present invention; and

FIG. 3 shows an embodiment of a sequence of method steps for verifying a content of an analog document, in accordance with embodiments of the present invention.

### DETAILED DESCRIPTION

FIG. 1 shows a device 10 for verifying a content 24 of an analog document 20, which will be described in greater detail with reference to FIG. 2.

The device 1 comprises a scanning unit 11, a verification unit 12 and a printing unit 13. Although shown as being integrated into one module, the scanning unit 11, the verification unit 12 and the printing unit 13 may be also located remote from each other.

The scanning unit 11 scans the analog document 20 and generates a scan information. The scan information is then stored in a storing element 21 being provided on the analog document 20.

The storing element 21 may be a binary code being printed or glued to the analog document 20. The storing element 21 may also be a digital secure element being embedded in the analog document 20.

The verification unit 12 verifies the content 24 of the analog document 20 using the stored scan information.

In one embodiment, the scan information may correspond to a signature which is generated using the scanned version of the analog document 20. In this case, the verification unit 12 may verify whether the stored signature corresponds to the actual content of the analog document.

In another embodiment, the scan information may correspond to a plurality of scanned versions of the analog document 20. In this case, the verification unit 12 may compare the stored scanned versions with an actual scanned version to verify the content of the analog document.

FIG. 2 shows an embodiment of an analog document 20 being used by the device 10.

The document comprises a reserved area 24 for analog content. Area 22 may contain a right-hand-side margin used for an horizontal error correction code. Area 23 may contain a bottom-side margin used for a vertical error correction code. Area 21 may be reserved for the storing element 21 in the form of a sticker or a direct print.

The signature 21 as well as the error correction codes in areas 22, 23 may be printed directly on the paper through a printer.

In order to calibrate the scanning unit 11, area 21, before adding the signature, there may be a calibration pattern already embedded in the paper. When the sticker 21 is brought to the document 21, it covers the calibration pattern but the format of the signature sticker 21 (e.g. width and length, etc.) may be used for calibration of the entire document 20. Alternatively, an additional area (not shown) may be added to the document 20, e.g. in the upper-right corner of the document 20 or in the top right or left or bottom left area. These area(s) may contain calibration patterns for the scanning unit 11 to work properly.

The calibration pattern may comprise an embedded identifier for the scanning unit 11 to be able to recognize which resolution (e.g. in DPI—dots-per-inch) to use for scanning the content 21.

The calibration pattern and/or the signature 21 may comprise information regarding a signing authority. It can also be omitted, in case it can be implicitly determined, e.g. from the analog information contained in area 24. It is also possible to manually select a signing authority in the verification terminal.

A signing authority may be used for example when some entity owns a private key which is not known by others and is used to digitally sign a document (e.g. by encrypting the result of some hash function). The public key, which is available to everyone, can be used to verify the signature. As long as the relationship between the owner of the public key and the public key itself can be asserted, the same can be said for the verification of the signature of some document. In particular, the process might go through a trusted certification authority which is used for asserting the relationship between the public key owner and the public key itself (through a chain of trust).

The following is a brief description of the expected life-cycle of the analog signed document 20. An individual takes an already properly formatted piece of paper which follows the patterns shown e.g. in FIG. 2, i.e. with different areas. The individual uses a pen to freely write in the area 24 (i.e. manually). When ready, the document can be given a digital signature by a signing authority, which may be the owner itself or a certifying authority like a government. Two situations might occur:

First, the document owner signs himself—the verification process can only state that the document 20 comes from the owner and the analog content 21 has not been changed.

Second, the document 20 may be signed by a signing authority (e.g. government or credited delegate). The document 20 might only be signed if some criteria are fulfilled (which may depend on the signing authority), e.g. the document owner is present. In this case, the signing authority (or a delegate thereof) may later verify the validity of the document 20 that was signed by said authority or delegate thereof. The trust chain is established by the usage of keys and the criteria used for issuing the analog signature.

FIG. 3 shows a method for verifying a content of an analog document. The method comprises the following steps:

In a first step 301, a scan information is generated by scanning the analog document 20.

In a second step 302, the scan information is stored in a storing element 21 being provided on the analog document 20.

In a third step 303, the content 24 of the analog document 20 is verified using the stored scan information.

Although the invention has been described and illustrated in detail by way of the preferred exemplary embodiment, the invention is not restricted by the disclosed examples and other variations can be derived herefrom by a person skilled in the art without departing from the scope of protection of the invention.

For the sake of clarity, it is to be understood that the use of ‘a’ or ‘an’ throughout this application does not exclude a plurality, and ‘comprising’ does not exclude other steps or elements.

1. A device for verifying a content of an analog document, the device comprising:
a scanning unit being configured to generate a scan information by scanning the analog document and to store the scan information in a storing element being provided on the analog document; and p1 a verification unit being configured to verify the content of the analog document using the stored scan information.

2. The device according to claim 1, wherein the scanning unit is configured to generate a digital signature based on the scan information and to store the digital signature in the storing element.

3. The device according to claim 2, wherein the scanning unit is configured to generate an error correction information when scanning the analog document and wherein the analog document includes a specific area on which the error correction information is providable.

4. The device according to claim 3, further comprising:
a printing unit being configured to print the error correction information to the specific area.

5. The device according to any one of claim 3, wherein the scanning unit is configured to generate a horizontal error correction information and a vertical error correction information.

6. The device according to claim 5, wherein the printing unit is configured to print the horizontal error correction information to a first segment of the specific area and to print the vertical error correction information to a second segment of the specific area.

7. The device according to claim 1, wherein the analog document includes a calibration pattern and wherein the scanning unit is configured to be calibrated using the calibration pattern before scanning the analog document.

8. The device according to claim 1, wherein the storing element is a visual representation of a binary code being attachable to the analog document.

9. The device according to claim 1, wherein the storing element is a digital secure element being included in the analog document.

10. The device according to claim 9, wherein the scanning unit is configured to store as scan information at least one scanned version of the analog document.

11. The device according to claim 10, wherein the verification unit is configured to scan the analog document and to generate a comparison result by comparing the scanned analog document with the at least one stored scanned version of the analog document.

12. The device according to claim 11, wherein the verification unit is configured to verify the content of the analog document based on the comparison result.

13. The device according to claim 10, wherein the scanning unit is configured to scan the analog document using different scanning parameters and to store for each scanning parameter one scanned version of the analog document.

14. The device according to claim 13, wherein the verification unit is configured to scan the analog document and to generate a plurality of comparison results by comparing the scanned analog document with each of the stored scanned versions of the analog document and to verify the content of the analog document using the plurality of comparison results.

15. A method for verifying a content of an analog document, the method comprising:
generating a scan information by scanning the analog document;
storing the scan information in a storing element being provided on the analog document; and
verifying the content of the analog document using the stored scan information.
